(19) United States
(12) Patent Application Publication
(10) Pub. No.: US 2010/0166194 A1
(43) Pub. Date: Jul. 1, 2010

(54) APPARATUS AND METHOD FOR PROCESSING AUDIO

(75) Inventors: Wen-Chun TSAO, TAIPEI HSIEN (TW); Fang-Yuan CHIU, TAIPEI HSIEN (TW); Kuo-Jung WANG, TAIPEI HSIEN (TW); Chun-Chieh CHEN, TAIPEI HSIEN (TW); Kuo-Hsing WANG, TAIPEI HSIEN (TW); Chia-Hsien LI, TAIPEI HSIEN (TW)

Correspondence Address: BRIAN M. MCINNIS, 12th Floor, Ruttonjee House, 11 Duddell Street, Hong Kong, HK

(73) Assignee: WISTRON CORP., Taipei Hsien (TW)

(21) Appl. No.: 12/569,907

(22) Filed: Sep. 30, 2009

(30) Foreign Application Priority Data
Dec. 26, 2008 (TW) 97150956

(51) Int. Cl. H04R 5/00

(52) U.S. Cl. 381/17

(57) ABSTRACT

In the specification and drawing an apparatus for processing audio is described and shown with an audio processor for acquiring at least one audio signal from an audio chip and transforming the audio signal into a surround sound signal and a transmitter for emitting the surround sound signal to a radio set. Moreover, a method for processing audio is also disclosed in the specification and drawing.

### RELATED APPLICATIONS

This application claims priority to Taiwan Application Serial Number 97150956, filed Dec. 26, 2008, which is herein incorporated by reference.

### BACKGROUND

1. Field of Invention

The present invention relates to a control method, system and equipment. More particularly, the present invention relates to an apparatus and a method for processing audio.

2. Description of Related Art

Both desktop and laptop computers have become popular for both commercial and personal use. The popularity of these devices has driven the rapid development of technologies applied therein. Laptops can in general use two sound channels to simulate surround sound; alternatively, laptops can be connected to a professional audio system to play surround sound, but it is expensive to buy the professional audio system.

In view of the foregoing, there is a need of surround sound without a heavy financial burden on consumers.

### SUMMARY

The following presents a simplified summary of the invention in order to provide a basic understanding to the reader. This summary is not an extensive overview of the invention and it does not identify key/critical elements of the present invention or delineate the scope of the present invention. Its sole purpose is to present some concepts disclosed herein in a simplified form as a prelude to the more detailed description that is presented later.

In one or more aspects, the present invention is directed to an apparatus and a method for processing audio.

In accordance with an embodiment of the present invention, the apparatus comprises an audio processor and a transmitter. The audio processor can acquire at least one audio signal from an audio chip and transform the audio signal into a surround sound signal; the transmitter can emit the surround sound signal to a radio set. Therefore, the radio set can play surround sound according to the surround sound signal.

In accordance with another embodiment of the present invention, the method comprises following steps: at least one audio signal is acquired from an audio chip and is transformed into a surround sound signal, and the surround sound signal emitted to a radio set. Therefore, the radio set can play surround sound according to the surround sound signal.

Many of the attendant features will be more readily appreciated, as the same becomes better understood by reference to the following detailed description considered in connection with the accompanying drawings.

### BRIEF DESCRIPTION OF THE DRAWINGS

The present description will be better understood from the following detailed description read in light of the accompanying drawings, wherein:

FIG. 1 is a block diagram of an apparatus for processing audio according to an embodiment of the present invention;

FIG. 2 is a flow chart of a method for processing audio according to another embodiment of the present invention;

FIG. 3 is another flow chart of the method for processing audio according to another embodiment of the present invention;

FIG. 4 is a flow chart of step 230 of FIG. 2; and

FIG. 5 is another flow chart of step 230 of FIG. 2.

Like reference numerals are used to designate like parts in the accompanying drawings.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

In one aspect, the present invention is directed to an apparatus for processing audio. The apparatus may be easily inserted into an existing device, such as a computer, and may be applicable or readily adaptable to all technologies.

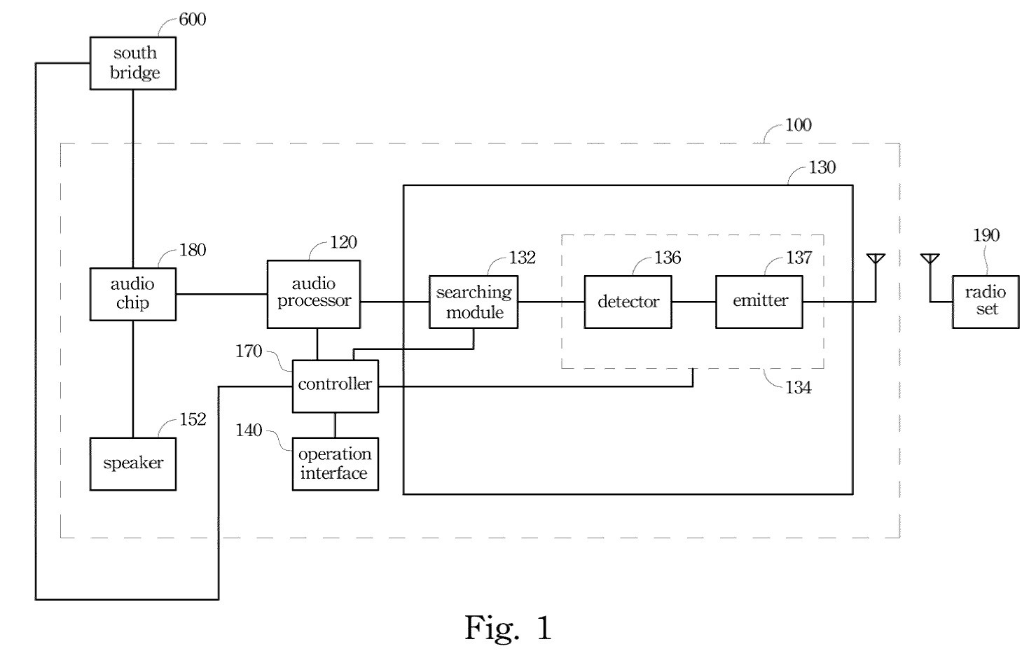

Please refer to FIG. 1. FIG. 1 is a block diagram of an apparatus 100 for processing audio according to an embodiment of the present invention. In FIG. 1, the apparatus 100 comprises an audio processor 120 and a transmitter 130. The apparatus 100 is separated from a radio set 190.

The audio processor 120 can acquire at least one audio signal from an audio chip 180 and transform the audio signal into a surround sound signal; the transmitter 130 can emit the surround sound signal to the radio set 190. Therefore, the radio set 190 can play surround sound according to the surround sound signal.

In practice, the radio set 190 has speakers on the left and right sides thereof. The radio set 190 can broaden the scope of a sound field to provide surround sound as though the interval between the speakers were increased. In addition, the radio set is cheaper than a professional audio system.

The audio processor 120 may be integrated in a 3D surround sound chip. For example, the 3D surround sound chip is a Sound Effect Processor IC-AA8334 provided by AGAMEM or TA2136FG/TA2136NG provided by TOSHIBA. The 3D surround sound chip is electrically coupled with the audio chip 180 for acquiring the audio signal. Alternatively, the audio processor 120 may be integrated in the audio chip 180. One of ordinary skill in the art will appreciate that the above 3D surround sound chips are provided for illustrative purposes only to further explain applications of the present invention and are not meant to limit the present invention in any manner. Other device and/or software may be used as appropriate for a given application.

The audio chip 180 may be an audio codec. The audio codec is electrically coupled with a south bridge 600 of a motherboard; thus, the motherboard can control the audio codec via the south bridge 600. One of ordinary skill in the art will appreciate that the above audio codec is provided for illustrative purposes only to further explain applications of the present invention and are not meant to limit the present invention in any manner. Other device and/or software may be used as appropriate for a given application.

The audio chip 180 has a plurality of sound channels; the audio processor 120 can acquire the audio signal from at least one of the sound channels. For example, the audio chip 180 has certain pins connecting the audio processor 120, and therefore the audio processor 120 can acquire the audio signal from at least one of the sound channels via these pins. For instance, the audio chip 180 may provide 4.1 surround sound, 5.1 surround sound, 7.1 surround sound or the like; the audio processor 120 can acquire the audio signal from two sound channels of the audio chip 180.

In FIG. 1, the apparatus 100 comprises a speaker 152. The speaker 152 can receive the audio signal from the audio chip 180 and play sound according to the audio signal. Accordingly, both the speaker 152 and the radio set 190 can play sound at the same time to create three-dimensional sound field effect.

For example, the apparatus 100 is employed in a laptop. The laptop in front of a user has the speaker 152; the radio set 190 in back of the user acts as a back surround audio. As using the apparatus 100, both the speaker 152 and the radio set 190 can play sound at the same time, whereby the user, surrounded by sound field, feels realistic sound effects.

In FIG. 1, the apparatus 100 may further comprise a controller 170 and an operation interface 140. The operation interface 140 can be operated to send instructions to the controller 170 to set a surround sound signal for an intensity value of a sound field. Accordingly, a user can operate the operation interface 140 to set the surround sound signal generated from the audio processor 120 for an intensity value of a sound field; the transmitter 130 can emit the surround sound signal to the radio set 190, whereby the user can wirelessly control the sound field of the radio set 190.

The operation interface 140 may comprise a keyboard and keyboard controller, so as to facilitate use. The keyboard is electrically coupled with the keyboard controller; the keyboard controller can be electrically coupled with a south bridge 600 of a motherboard. One of ordinary skill in the art will appreciate that the above examples are provided for illustrative purposes only to further explain applications of the present invention and are not meant to limit the present invention in any manner. Alternatively, another human-machine interface, such as a touch screen, may be used as appropriate for a given application.

The transmitter 130 may be a frequency-modulated transmitter, so as to transmit a signal in frequency band of frequency modulation broadcasting, such as 88-108 MHz. Moreover, the surround sound signal generated by the audio processor 120 belongs to an analog signal. In other embodiment, the transmitter 130 may be a wireless communications device, such as a bluetooth module or the like.

In FIG. 1, the transmitter 130 comprises a searching module 132 and a transmission module 134. The searching module 132 can search at least one frequency channel; the transmission module 134 can emit the surround sound signal to the radio set 190 in the frequency channel. Accordingly, the radio set 190 can play surround sound according to the surround sound signal.

For instance, the apparatus 100 is employed in a computer, and the transmitter 130 is a frequency-modulated transmitter. A user can use the operation interface 140 to input search instructions; the controller 170 can then instruct the searching module 132 to search one or more available frequency channels of modulation frequency bands according to the search instruction and then transmit information of the available frequency channels to the controller 170. The controller 170 can transmit the information of the available frequency channels to the south bridge 600, whereby the screen of the computer can display the information of the available frequency channels. Therefore, the user can use the operation interface 140 to select one of the available frequency channels, and then the controller 170 can acquire information of the selected available frequency channel. The controller 170 can transmit the information of the selected available frequency channel to the transmission module 134. The transmission module 134 can emit the surround sound signal to the radio set 190 in the selected available frequency channel.

The searching module 132 and the transmission module 134 comprise electric circuits respectively. Additionally or alternatively, the searching module 132 and the transmission module 134 may further comprise software program respectively.

In FIG. 1, the transmission module 134 comprises a detector 136 and an emitter 137. The detector 136 can detect whether the frequency channel is interfered by noise; the emitter 137 can emit the surround sound signal to the radio set 190 in the frequency channel when the frequency channel is not interfered with by noise. Moreover, the searching module 132 can search one or more available frequency channels.

For instance, the apparatus 100 is employed in a computer, and the transmitter 130 is a frequency-modulated transmitter. A user can use the operation interface 140 to input search instructions; the controller 170 can instruct the searching module 132 to search one or more available frequency channels of modulation frequency bands according to the search instruction and then transmit information of the available frequency channels to the controller 170. The controller 170 can transmit the information of the available frequency channels to the south bridge 600, whereby the screen of the computer can display the information of the available frequency channels. Therefore, the user can use the operation interface 140 to select one of the available frequency channels, and then the controller 170 can acquire information of the selected available frequency channel. The controller 170 can transmit the information of the selected available frequency channel to the transmission module 134. In the transmission module 134, the detector 136 detects whether the selected available frequency channel is interfered by noise, and then the emitter 137 can emit the surround sound signal to the radio set 190 in the frequency channel when the selected available frequency channel is not interfered by noise. On the contrary, the detector 136 can respond to the controller 170 when the selected available frequency channel is not interfered by noise. The controller 170 can transmit the information of the available frequency channels interfered by noise to the south bridge 600, whereby the screen of the computer can display the information of the available frequency channels. Accordingly, the user can use the operation interface 140 to input search instruction anew; the controller 170 can instruct the searching module 132 to search one or more available frequency channels in frequency band of frequency modulation broadcasting according to the search instruction.

In one aspect, the present invention is directed to a method for processing audio. The method may be easily embodied into an existing device, such as a computer, and may be applicable or readily adaptable to all technologies.

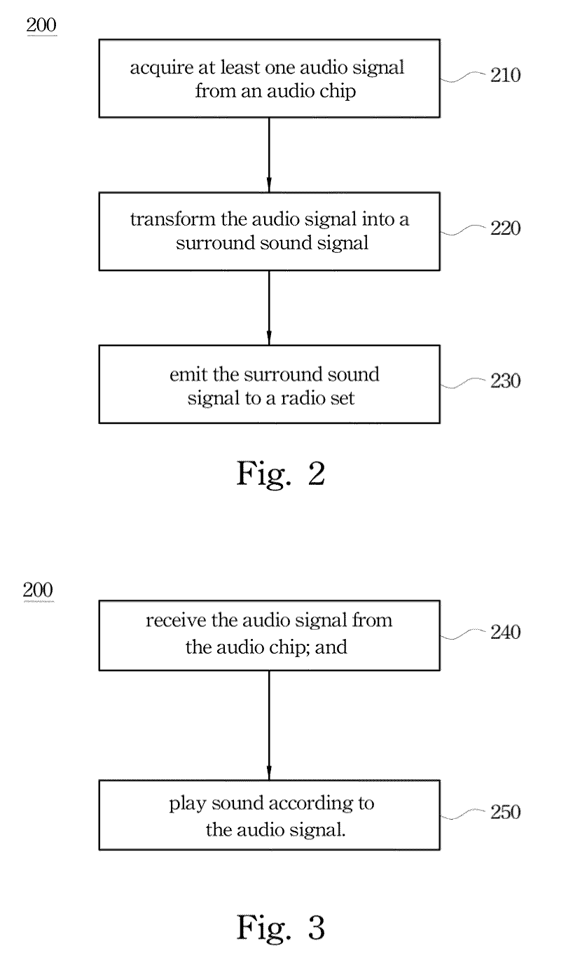

Please refer to FIG. 2. FIG. 2 is a flow chart of a method 200 for processing audio according to another embodiment of the present invention. The method 200 comprises step 210, step 220 and step 230. In the method 200, it should be noted that one step might be performed in series, in parallel, in combination, or otherwise in conjunction with another if the specific order is not described or inferred in the embodiment. The apparatus of performing the method 200 is described in the preceding embodiment and, thus, are not repeated herein.

In step 210, at least one audio signal is acquired from an audio chip; in step 220, the audio signal is transformed into a surround sound signal; in step 230, the surround sound signal is emitted to a radio set.

In practice, the radio set 190 has speakers on the left and right sides thereof. The radio set 190 can broaden scope of a sound field to play surround sound as though the interval of speakers was increased. In addition, the radio set is cheaper than a professional audio system.

The audio chip has a plurality of sound channels. In step 210, the audio signal is acquired from at least one of the sound channels. For example, the audio chip has certain pins connecting the audio processor 120, and therefore the audio signal is acquired from at least one of the sound channels via these pins. For instance, the audio chip 180 may provide 4.1 surround sound, 5.1 surround sound, 7.1 surround sound or the like; in step 210, the audio signal is acquired from two sound channels of the audio chip 180.

In step 220, the surround sound signal is set for an intensity value of a sound field. Accordingly, a user can operate the operation interface 140 to set the surround sound signal for the intensity value of the sound field, and then the surround sound signal is emitted to the radio set, whereby the user can indirectly control the sound field of the radio set.

Please refer to FIG. 3. FIG. 3 is another flow chart of the method 200 for processing audio according to another embodiment of the present invention. The method 200 comprises step 240 and step 250. In step 240, the audio signal is received from the audio chip; in step 250, sound is played according to the audio signal. Accordingly, the sound could be played by synchronously performing step 230 and step 250, for creating three-dimensional sound field effect.

For example, the method 200 is employed in a laptop. The laptop in front of a user acts as a speaker; the radio set 190 at the back of the user acts as an audio system. When performing the method 200, both the speaker and the radio set can play sound at the same time, whereby the user, surrounded by sound field, feels realistic sound effects.

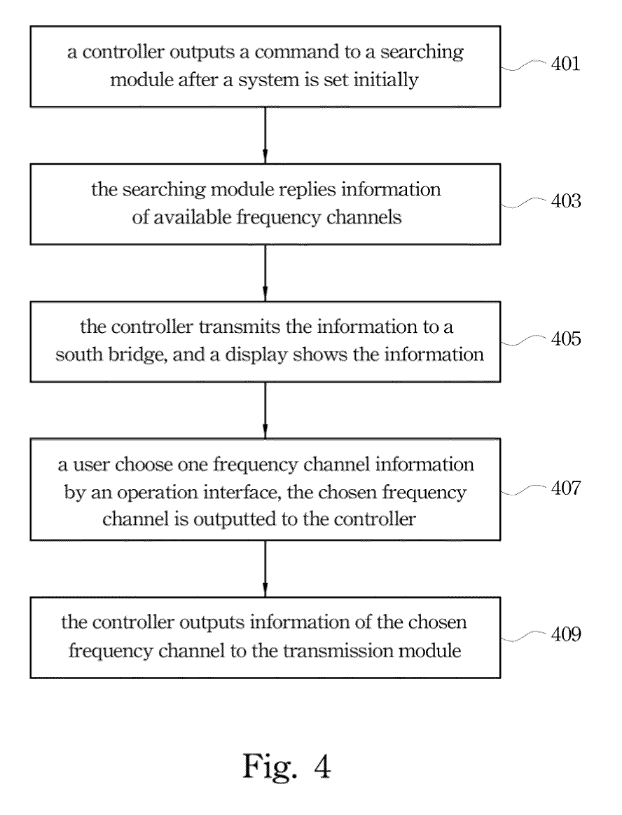

Please refer to FIG. 4. FIG. 4 is a flow chart of step 230 of FIG. 2. In FIG. 4, step 230 comprises sub-step 401, sub-step 403, sub-step 405, sub-step 407 and sub-step 409.

In sub-step 401, a controller outputs a command to a searching module after a system, such as the above apparatus 100, is set initially. In sub-step 403, the searching module replies information of available frequency channels. In sub-step 405, the controller transmits the information to a south bridge, and a display shows the information. In sub-step 407, a user chooses one frequency channel by an operation interface, and then the chosen frequency channel information is outputted to the controller. In sub-step 409, the controller outputs information of the chosen frequency channel to the transmission module.

For instance, the method 200 is employed in a computer, in which step 230 is employed in a frequency-modulated transmitter. A user can use the operation interface to input search instruction; the controller can order the searching module to search one or more available frequency channels in frequency band of frequency modulation broadcasting according to the search instruction and then transmit information of the available frequency channels to the controller. The controller can transmit the information of the available frequency channels to the south bridge 600, whereby the screen of the computer can display the information of the available frequency channels. Therefore, the user can use the operation interface to select one of the available frequency channels, and then the controller can acquire information of the selected available frequency channel. The controller can transmit the information of the selected available frequency channel to the transmission module. The transmission module can emit the surround sound signal to the radio set in the selected available frequency channel

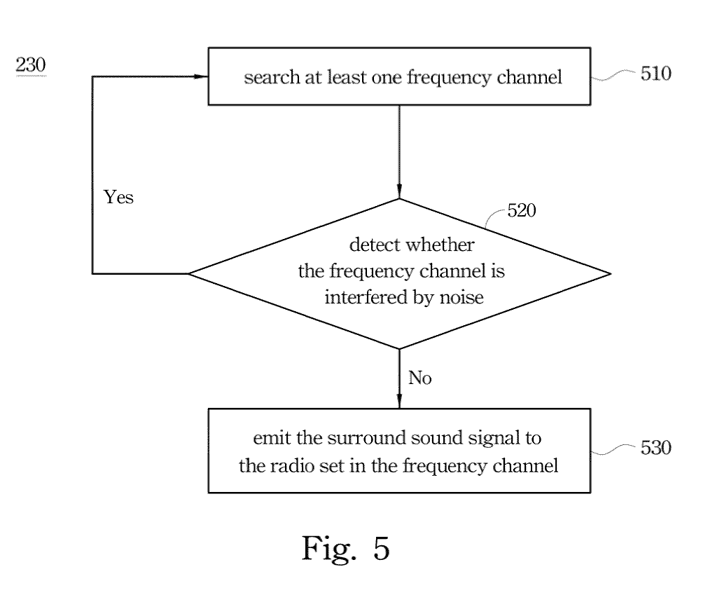

Please refer to FIG. 5. FIG. 5 is another flow chart of step 230 of FIG. 2. In FIG. 4, step 230 comprises sub-step 510, sub-step 520 and sub-step 530. During sub-step 510, at least one frequency channel is searched; during sub-step 520 and sub-step 530, the surround sound signal to the radio set in the frequency channel. In sub-step 520, whether the frequency channel is interfered by noise is detected; in sub-step 530, the surround sound signal is emitted to the radio set in the frequency channel when the frequency channel is not interfered by noise. On the contrary, one or more available frequency channels are searched anew in sub-step 510 when the frequency channel is interfered by noise.

For instance, the method 200 is employed in a computer, in which step 230 is employed in a frequency-modulated transmitter. A user can use the operation interface to input search instruction to execute sub-step 510; in sub-step 510, one or more available frequency channels of modulation frequency bands and then information of the available frequency channels is transmitted to the computer; the screen of the computer can display the information of the available frequency channels. Therefore, the user can use the operation interface to select one of the available frequency channels, and then whether the frequency channel is interfered by noise is detected in sub-step 520. The surround sound signal is emitted to the radio set in the frequency channel in sub-step 530 when the frequency channel is not interfered by noise. On the contrary, one or more available frequency channels of frequency modulation broadcasting are searched anew in sub-step 510 when the frequency channel is interfered by noise.

The foregoing outlines features of several embodiments so that those skilled in the art may better understand the aspects of the present invention. Those skilled in the art should appreciate that they may readily use the present invention as a basis for designing or modifying other processes and structures for carrying out the same purposes and/or achieving the same advantages of the embodiments introduced herein. Those skilled in the art should also realize that such equivalent constructions do not depart from the spirit and scope of the present invention, and that they may make various changes, substitutions and alterations herein without departing from the spirit and scope of the present invention.

What is claimed is:

1. An apparatus for processing audio, comprising:
an audio processor for acquiring at least one audio signal from an audio chip and transforming the audio signal into a surround sound signal; and
a transmitter for emitting the surround sound signal to a radio set.

2. The apparatus as claimed in claim 1, wherein the audio chip has a plurality of sound channels, and the audio processor acquires the audio signal from at least one of the sound channels.

3. The apparatus as claimed in claim 1, further comprising:
at least one speaker for receiving the audio signal from the audio chip and playing sound according to the audio signal.

4. The apparatus as claimed in claim 1, wherein the transmitter is a frequency-modulated transmitter.

5. The apparatus as claimed in claim 1, wherein the transmitter comprising:
a searching module for searching at least one frequency channel; and
a transmission module for emitting the surround sound signal to the radio set in the frequency channel.

6. The apparatus as claimed in claim 5, wherein the transmission module comprising:
a detector for detecting whether the frequency channel is interfered with by noise: and
an emitter for emitting the surround sound signal to the radio set in the frequency channel when the frequency channel is not interfered by noise.

7. The apparatus as claimed in claim 1, further comprising:
a controller; and
an operation interface for ordering the controller to set the surround sound signal for an intensity value of a sound field.

8. A method for processing audio, comprising steps of:
(a) acquiring at least one audio signal from an audio chip;
(b) transforming the audio signal into a surround sound signal; and
(c) emitting the surround sound signal to a radio set.

9. The method as claimed in claim 8, wherein the audio chip has a plurality of sound channels, the step (a) comprises:
acquires the audio signal from at least one of he sound channels.

10. The method as claimed in claim 8, further comprising:
(d) receiving the audio signal from the audio chip; and
(e) playing sound according to the audio signal.

11. The method as claimed in claim 8, wherein the step (c) comprises:
searching at least one frequency channel; and
emitting the surround sound signal to the radio set in the frequency channel.

12. The method as claimed in claim 11, wherein emitting the surround sound signal to the radio set in the frequency channel comprises:
detecting whether the frequency channel is interfered by noise; and
emitting the surround sound signal to the radio set in the frequency channel when the frequency channel is not interfered by noise.

13. The method as claimed in claim 8, further comprising:
setting the surround sound signal for an intensity value of a sound field.
